(19) United States
(12) Patent Application Publication
(10) Pub. No.: US 2007/0041157 A1
(43) Pub. Date: Feb. 22, 2007

(54) Heat dissipation apparatus

(76) Inventor: David Gang Wang, San Diego, CA (US)

Correspondence Address: DAVID G. WANG, 13828 ESPRIT AVE., SAN DIEGO, CA, 92128, US

(21) Appl. No.: 11/205,843

(22) Filed: Aug. 18, 2005

(51) Int. Cl. G06F 1/20

(52) U.S. Cl. 361/687

(57) ABSTRACT

The heat dissipating apparatus is a cooling system that can be used to cool a heat-generating electronic component, such as a CPU (Central Processing Unit), within an enclosure, such as a computer. The cooling system includes a heat receiving section that is thermally and mechanically coupled to the heat-generating electronic component. Heat received in the heat receiving section is transferred to a heatsink that is coupled to the heat receiving section. To dissipate heat from the heatsink, an air flow device, such as a fan or axial blower, is provided. The air flow device is movable from a retracted position, where it is completely inside the enclosure, to an extended position, where it is at least partially outside the enclosure. In the extended position, the air flow device is able to intake air with less airflow impedance than in the retracted position. An increase in airflow to the heatsink can therefore be achieved by having the air flow device in the extended position.

### CROSS-REFERENCE OF RELATED APPLICATIONS

Not Applicable

### STATEMENT REGARDING FEDERALLY SPONSORED RESEARCH OR DEVELOPMENT

Not Applicable

### REFERECE TO SEQUENCE LISTING, A TABLE, OR A COMMPUTER PROGRAM LISTING COMPACT DISC APPENDIX

Not Applicable

### BACKGROUND OF THE INVENTION

Electronic and computer systems are equipped with heat generating electronic and integrated circuit (IC) devices and components, such as CPUs (Central Processing Units) for processing various types of data and information. The amount of heat generated by CPUs and other heat generating components is increasing significantly over time due to the increase in the processing speed and/or enhancement of versatility and functionality. Accordingly, to maintain the electronic and computer systems in general, and CPU and other heat generating components in particular in a stable and reliable state, it is necessary to increase the capability of heat removal and dissipation from the CPUs and those heat generating components.

Modern electronic and computer systems typically have at least one cooling system for forcibly air cooling the CPU and/or other heat generating components. A cooling system, such as that shown in FIG. 14, typically comprises a heat-receiving section 1400, a heatsink 1405, a coupling device 1410 thermally coupling the heat-receiving section 1400 and the heatsink 1405, and an air flow device (not shown).

The heat-receiving section 1400 is made of thermally conductive material and is thermally and mechanically coupled to the CPU or other heat generating components to receive heat. The heatsink 1405 has extended surface areas such as fins made of thermally conductive materials and is thermally coupled to the heat-receiving section 1400 such that heat absorbed by the heat-receiving section 1400 can be efficiently transferred to the heatsink 1405. The heat-receiving section 1400 can be integral with the heatsink 1405, such as commonly found in desktop computers or may be a physically separate unit from the heatsink such as commonly found in mobile computing environments.

The air flow device draws cooling air in from ambient, forces cooling air to flow past the heatsink surfaces, and exhausts the heated air out of the enclosure thus removing heat from the heat generating components. The air flow device is typically chosen from radial impellers/blowers or axial fans.

For blowers, the air inlet can be at one side or both and opposite sides of a generally thin case. A single air outlet or multiple air outlets can be at the side, or the whole side can be the air outlet. As such, airflow direction at the inlet is perpendicular to that at the outlet. Axial fans, on the other hand, have the air inlet on one side of the flat surface and the outlet on the opposite side such that airflow direction at the inlet is the same as that at the outlet.

The cooling capability of a cooling system is determined by, among many important factors, the size or the total exposed surface area of the heatsink and cooling air delivery capacity of the air flow device. In general, use of a big heatsink and/or a big and powerful air flow device will result in a cooling solution with higher cooling capability.

However, a computer system employing a faster and hotter CPU may not have the necessary space allocated for a bigger cooling system. This is typically the case with modern mobile computers such as portable and laptop computers and other computing and data processing devices such as low profile workstations and servers. The requirement of a thin profile enclosure necessitates the use of radial blowers as air flow devices and low profile heatsinks in a mobile computer and other low profile and compact electronic device environment. Blowers invariably have low airflow delivery capacity as compared to axial fans of similar size. Moreover, physical limitations brought about by small form factor chassis enclosures also restrict airflow. In laptop computers, air intake is typically from a very narrow gap between the bottom surface of the laptop base and a working surface that the laptop rests on. The narrow gap can significantly increase airflow impedance rendering lower volumetric flow delivered by the blower.

Low profile heatsinks also have limited way of effectively increasing surface areas. To increase the surface area of a thin heatsink, more fins have to be packed into a fixed width and/or longer fins in the direction of airflow have to be used. Unfortunately, an increase in surface area accomplished by the aforementioned methods will inevitably result in tighter spaces between fins thus high airflow impedance. As such, for a given blower, improvement in cooling capacity can only be achieved to a certain extent, beyond which, increase in surface area will not yield meaningful cooling capacity improvement.

To meet the increasing cooling requirements for hotter CPUs, multiple heatsinks and multiple air flow devices such as blowers are used in low profile mobile computers resulting in undesirably large and heavy chassis enclosures. More cooling solutions lead to more parts, parts of increased complexity, increased effort in assembly and therefore higher costs. More blowers in a chassis enclosure also lead to high fan noise and lower reliability.

To summarize, the limitation in conventional cooling solutions for low profile chassis enclosures is becoming a road blocker for manufacturers to build small form factor computers that can meet the market demand for incorporating the fastest CPUs in mobile computers as well as the smallest and most compact form factor for the mobile computers' physical size.

In order to meet the aforementioned market demands on CPU speed and mobile computer size simultaneously, cooling solution must be designed differently with better and improved cooling efficiency.

### BRIEF SUMMARY OF THE INVENTION

Described below is a cooling system and method designed to cool heat generating electronic components such as a CPU (Central Processing Unit) in electronic and computer system enclosures incorporating the cooling system. More particularly, the cooling system and method may be used to remove heat from high heat dissipating components located within small form factor electronic and computer devices such as mobile computers having a main body portion and a display portion connected in an operable manner to the main body portion.

In this description, a laptop is used as an example device in which the cooling system is used. It will be appreciated that the cooling system as described can be used in electronic devices of other forms, non-limiting examples of which include other forms of computing and data processing devices. Furthermore, the cooling systems in this description are described using one heat receiving section and one heatsink. It should be understood that cooling systems comprising multiple heat generating components with multiple heat receiving sections, multiple heatsinks and multiple air flow devices will also work according to cooling solution principles outlined in the following description.

One form of the system described below is a cooling system for a device having an enclosure and at least one heat-generating electronic component operating within the enclosure. The system includes a heat receiving section thermally and mechanically coupled to the heat-generating electronic component and a heatsink thermally and mechanically coupled to the heat receiving section. There is also an air flow device movable between a retracted position, where the air flow device is completely inside the enclosure, and an extended position, where the air flow device is at least partially outside the enclosure. The cooling system can be designed to operate with the air flow device in the retracted position as well as in the extended position. Alternatively, the cooling system can be designed to operate with the air flow device in the extended position only.

In the extended position, the air flow device is adapted to direct air to the heatsink to dissipate heat that is transferred from heat generating component. When operation is required in the retracted position, the air flow device is also adapted to direct air to the heatsink for heat removal.

Another form of the cooling system utilizes a blower movable between a retracted position, where the blower is completely inside the enclosure, and an extended position, where the blower is at least partially outside the enclosure. The blower in the extended position is adapted to direct air to the heatsink to dissipate heat from the heatsink. The blower can also be adapted to direct air to the heatsink for heat removal if operation is required in the retracted position.

A further form of the cooling system utilizes a first blower movable between a retracted position, where the blower is completely inside the enclosure, and an extended position, where the blower is at least partially outside the enclosure; wherein the blower in the extended position is adapted to direct air into the enclosure to dissipate heat from the heatsink. There is a second blower provided underneath the first blower, the second blower being fixed in a retracted position and adapted to direct air into the enclosure in the fixed retracted position.

A further form of the cooling system utilizes a lower blower fixed in a retracted position where the lower blower is completely inside the enclosure; and an upper blower located over the lower blower. The upper blower is movable between a retracted position, where the upper blower is completely inside the enclosure, and an extended position, where the upper blower is at least partially outside the enclosure. In this form, the lower blower is adapted to direct air to the heatsink for heat removal in the retracted position and the upper blower is adapted to direct air to the heatsink in the extended position.

In a further form, the system utilizes an axial fan movable between a retracted position, where the fan is completely inside the enclosure, and an extended position, where the fan is at least partially outside the enclosure. The fan is adapted to direct air to the heatsink in the extended position. The fan can also be adapted to direct air to the heatsink for heat removal in the retracted position if operation of the cooling solution with the fan in retracted position is required.

In a further form, the system includes a movable cover under the heatsink. An axial fan is movable between a retracted position, where the fan is completely inside the enclosure, and an extended position, where the fan is moved out from underneath the enclosure so as to be at least partially outside the enclosure. In the extended position, the movable cover is moved so as to expose an underside portion of the heatsink and the fan is moved so as to direct air to the heatsink at least through the exposed underside portion of the heatsink. The fan can also be adapted to direct air to the heatsink for heat removal in the retracted position if operation of the cooling solution with the fan in retracted position is required.

A still further form of the cooling system includes a heat receiving means thermally and mechanically coupled to the heat-generating electronic component for conducting heat away from the component and a heatsink means thermally and mechanically coupled to the heat receiving means for dissipating heat from the component. There is also an air flow means for directing air into the enclosure. The air flow means is movable between a retracted position, where the air flow means is completely inside the enclosure, and an extended position, where the air flow means is at least partially outside the enclosure. The air flow means directs air to the heatsink for removing heat transferred from the heat generating component in the extended position. The air flow means can also be adapted to direct air to the heatsink for heat removal in the retracted position if operation of the cooling solution with the air flow means in retracted position is required

One form of the cooling method includes the steps of transferring heat from the heat-generating electronic component to a heatsink, directing air to the heatsink to dissipate heat from the heatsink using an air flow device; and moving the air flow device from a retracted position, where the air flow device is completely inside the enclosure, to an extended position, where the air flow device is at least partially outside the enclosure.

In another form, the method comprises the steps of transferring heat from the heat- generating electronic component to a heatsink; directing air to the heatsink to dissipate heat from the heatsink using a lower blower; moving an upper blower from a retracted position, where the upper blower is located over the lower blower and is completely inside the enclosure, to an extended position, where the upper blower is at least partially outside the enclosure; and directing air into the enclosure to dissipate heat from the heatsink using the upper blower.

A further form of the method comprises the steps of transferring heat from the heat-generating electronic component to a heatsink; directing air to the heatsink to dissipate heat from the heatsink using an axial fan; moving a cover from underneath the heatsink so as to expose at least a portion of the underside of the heatsink; and moving the fan from a retracted position, where fan is completely inside the enclosure, to an extended position, where the fan substantially covers and directs air to the heatsink through the exposed underside portion of the heatsink for heat removal.

Other features and advantages will become apparent from the description and claims that follow.

### BRIEF DESCRIPTION OF THE SEVERAL VIEWS OF THE DRAWINGS

FIG. 1A is a perspective view of the first embodiment cooling system in a retracted position in a laptop computer.

FIG. 1B is a plan view of the cooling system of FIG. 1A.

FIG. 1C is a side view of the cooling system of FIG. 1A.

FIG. 2A is a perspective view of the first embodiment cooling system in an extended position.

FIG. 2B is a plan view of the cooling system of FIG. 2A showing the rotating out option for extension of the blower.

FIG. 2C is a plan view of the cooling system of FIG. 2A showing the sliding out option for extension of the blower.

FIGS. 3A to 3D are plan views showing possible locations of the first embodiment cooling system in a laptop computer.

FIG. 4A is a side view of the second embodiment cooling system in a retracted position in a laptop computer.

FIG. 4B is a plan view of the cooling system of FIG. 4A in the extended position using rotating out option.

FIG. 4C is a plan view of the cooling system of FIG. 4A in the extended position using sliding out option.

FIGS. 5A to 5D are plan views showing possible locations of the second embodiment cooling system in a laptop computer.

FIG. 6A is a perspective view of the third embodiment cooling system in a retracted position.

FIG. 6B is a side view of the cooling system of FIG. 6A.

FIG. 6C is a plan view of the cooling system of FIG. 6A.

FIG. 7A is a perspective view of the third embodiment cooling system in an extended position.

FIG. 7B is a side view of the cooling system of FIG. 7A.

FIGS. 7C and 7D are plan views of the cooling system of FIG. 7A from the retracted position to extended position using rotating out option.

FIGS. 7E and 7F are plan views of the cooling system of FIG. 7A from the retracted position to extended position using sliding out option.

FIGS. 8A to 8D are plan views showing possible locations of the third embodiment cooling system in a laptop computer.

FIG. 9A is a side view of the fourth embodiment cooling system in a retracted position.

FIG. 9B is a side view of the fourth embodiment cooling system in an extended position.

FIGS. 10A to 10D are plan views showing possible locations of the fourth embodiment cooling system in a laptop computer.

FIG. 11A is a perspective view of the fifth embodiment cooling system in a retracted position in a laptop computer.

FIG. 11B is a side view of the cooling system of FIG. 11A.

FIG. 11C is a plan view of the cooling system of FIG. 11A.

FIG. 12A is a perspective view of the fifth embodiment cooling system in an extended position in a laptop computer.

FIG. 12B is a side view of the cooling system of FIG. 12A.

FIGS. 13A to 13D are plan views showing possible locations of the fifth embodiment cooling system in a laptop computer.

FIG. 14 is a perspective view of some of the components in an example cooling system.

### DETAILED DESCRIPTION OF THE INVENTION

The cooling system of the present invention provides for the air flow device in the cooling system to move at least partially outside an electronic device enclosure within which the cooling system and the electronic components to be cooled are housed. The electronic device can perform any computing and/or data processing functions. For clarity, the movement and position of the air flow device out of the enclosure will be referred to as ‘extension’ and ‘extended’ respectively, and the movement and position of the air flow device into the enclosure will be referred to as ‘retraction’ and ‘retracted’ respectively.

The extension and retraction of the air flow device may involve rotational and/or translational movements that can be easily accomplished by conventional mechanisms such as gear groups, linear motors, stepper motors, actuators or the like. The extension and retraction of the air flow device may be activated manually by a user such as by turning a thumbwheel or a push of a button that will allow an electrical motor to drive the gear group to achieve certain predetermined combination of translational and/or rotational motions. The extension and retraction can also be activated automatically. In the case of a laptop computer, the automatic activation may be triggered by opening the display panel of the laptop computer to extend the air flow device out of the enclosure and by closing the display panel of the laptop computer to retract the air flow device into the inside of the enclosure.

In the case of a laptop or a mobile computing device, the extension and retraction may be based on an operating mode of the laptop. Depending on user preference and/or operation requirements, the laptop can operate in two different modes. In a battery savings mode or low power mode, the CPU operates at a low clock speed and thus consumes less power and generates less heat. In this mode, the air flow device may be configured to operate in the retracted position. In a high power mode, the CPU runs at full speed and generates maximum power. Here, the air flow device moves to the extended position. In a further alternative, the laptop can operate in only one mode with the air flow device operating in the extended position once the computer is powered on.

The air flow device is typically chosen from radial impellers/blowers or axial fans. For blowers, the air inlet can be at one side or both and opposite sides of a generally thin case. A single air outlet or multiple air outlets can be at the side, or the whole side can be the air outlet. As such, airflow direction at the inlet is perpendicular to that at the outlet. Axial fans, on the other hand, have the air inlet on one side of the flat surface and the outlet on the opposite side such that airflow direction at the inlet is the same as that at the outlet.

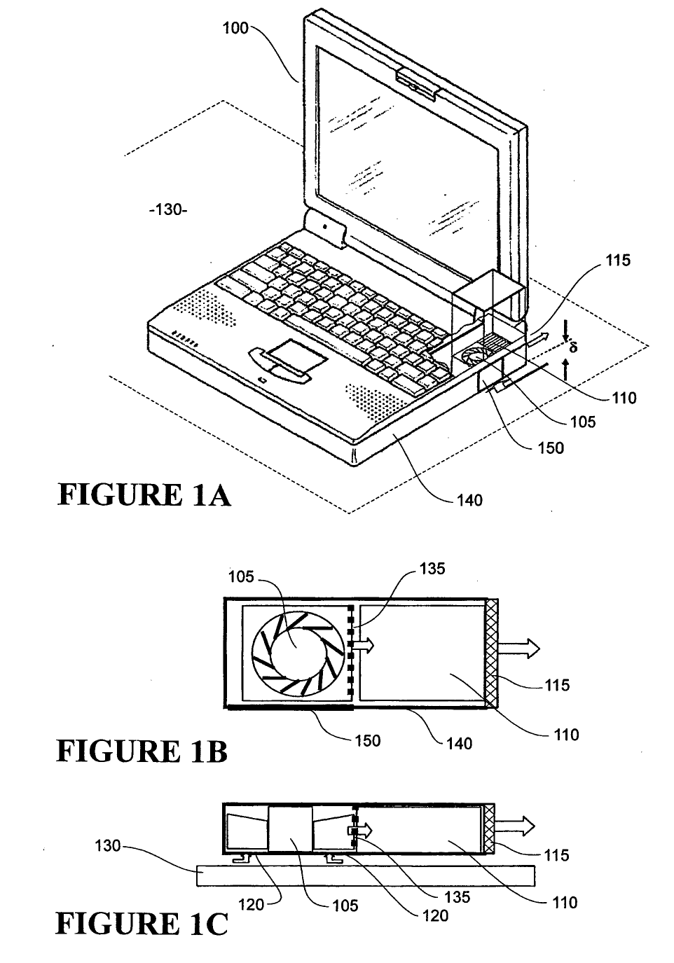

FIG. 1A shows a laptop 100 having the first embodiment cooling system installed in a retracted position in the enclosure of the main body of the laptop 100. The cooling system includes a blower 105 operating as an air flow device and a heatsink 110. The heatsink 110 may be provided with extended surfaces such as plate fins, pin fins or other forms of surfaces that can be either unidirectional or omni directional depending on design requirements.

In this embodiment, the blower 105 is movable between a retracted position with the blower 105 inside the enclosure and an extended position with the blower 105 extended at least partially out of the enclosure.

In the retracted position, the cooling system can be adapted to work in a manner very similar to conventional cooling systems for laptop computers when operation of the cooling system in the retracted position is required.

FIGS. 1B and 1C respectively show a top and side view of the first embodiment cooling system that is operational in a retracted position in a laptop computer. The blower 105 is located inside the main body enclosure with the bottom air inlet, generally shown as 120 exposed to the exterior of the enclosure through air inlet vents at the bottom surface of the enclosure. As such, the air inlet 120 is aligned with and faces the air inlet vents which generally have a cross sectional area that is at least similar to the cross sectional area of the air inlet 120.

To facilitate airflow communication between the blower air inlet 120 and ambient through air inlet vents at the enclosure bottom, downward protruding standoffs attached to the bottom surface of the enclosure may be provided to elevate the enclosure off the working surface, such as a table top surface 130, and create a gap to provide the air inlet 120 access to air.

In operation, the blower 105 draws air from its air inlet 120, through air inlet vents on the bottom surface of the enclosure and the gap. Referring to FIGS. 1A to 1C, air drawn into the air inlet 120 of the blower 105 is discharged at the blower air outlet, represented as 135, located on the side of the blower 105 facing the heatsink 110. The air from the air outlet 135 then flows to the heatsink 110 whose fins are aligned such that air can flow past the fins and out into the ambient through exhaust vents 115 located on the peripheral surface 140 of the enclosure.

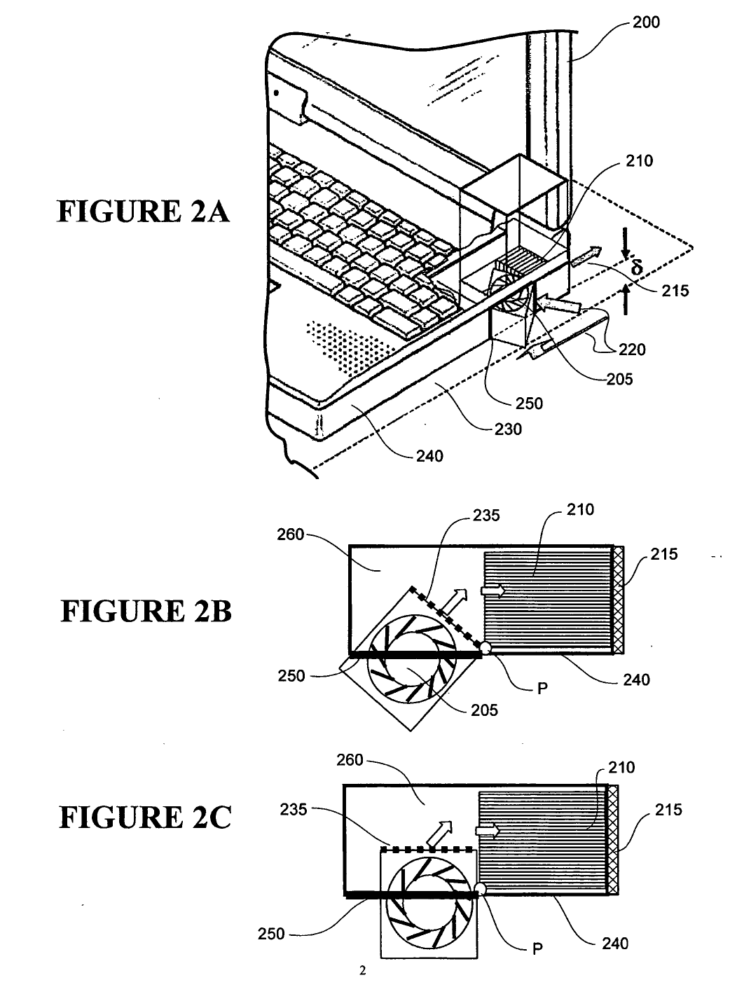

FIG. 2A shows the first embodiment cooling system in an extended position outside the enclosure of the main body of the laptop 200. The blower 205 in this embodiment has been moved so that the blower 205 is at least partially outside of the laptop enclosure. In the depiction, about one-half of the blower 205 is located outside the enclosure. The extension of the blower 205 may be realized by first providing an aperture shown as 150 in FIG. 1A on the peripheral surface 140 and as 250 in FIG. 2A on the peripheral surface 240 of the laptop from which the blower 205 may extend. In one option, with reference to FIGS. 2A and 2B, the blower outlet 235 will face the heatsink 210 when the blower 205 is in retracted position in the same way that FIGS. 1A to 1C depict. The blower 205 extends out of the aperture 250 by rotating the blower 205 about a fixed pivot P, as shown in FIG. 2B.

When the blower 205 is in the extended position, air is drawn and directed into the blower chamber 260 in which the blower 205 was positioned in the retracted position to force air into and to dissipate heat from the heatsink 210. However, instead of air being drawn into the blower only through a generally narrow gap into bottom air inlet 120 as described above in FIG. 1B, air is drawn into the blower through bottom and top inlets 220 that are at least partially open to the ambient. As a result of the blower 205 being at least partially outside, airflow impedance at the air inlets 220 is reduced and airflow discharge from blower outlet 235 into the blower chamber 260 increases. The air from the blower chamber 260 then flows through the fins of the heatsink 210 and out through exhaust vents 115

To completely extract or extend the blower 205, the blower 205 is rotated out along a fixed pivot P so that when the blower 205 is completely outside, the outlet 235 faces the aperture 250 on the peripheral surface 240 and directs air into the blower chamber 260.

The cooling system described above can operate both in the retracted position and in the extended position. If it is required for the first embodiment cooling system to work only in the extended position, the following option can be used in addition to the rotating out option described above. The position of the air outlet 235 of the blower can be located on the side of the blower 205 opposite the aperture 250 in the retracted position as illustrated in FIG. 2C. With the air outlet 235 facing away from the heatsink 210, the cooling system is not operational when the blower 205 is in the retracted postion and therefore, the blower 205 is powered off in the retracted position. When extended, the blower 205 slides out through the aperture 250 so that the outlet 235 faces and directs air into the blower chamber 260. Again, partial or full extension can be accomplished by sliding blower 205 out of the enclosure.

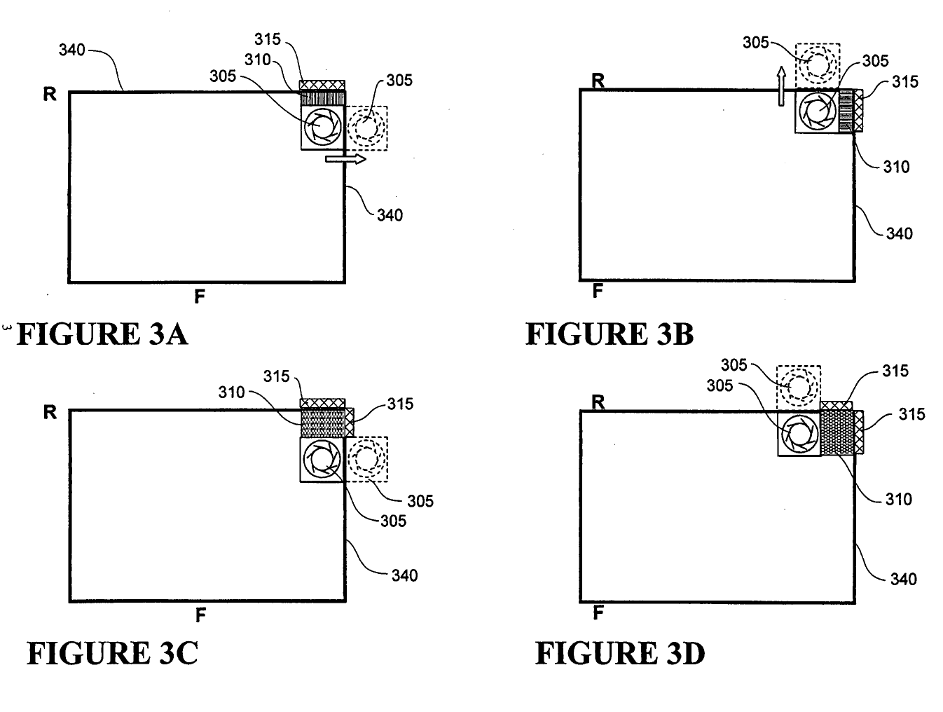

FIGS. 3A and 3B show possible locations of the cooling system of the first embodiment in a laptop computer. The front of the laptop, where a keyboard and pointing device are normally located is indicated as ‘F’, while the rear of the laptop is indicated as ‘R’. The blower 305 is shown in solid lines in the retracted position and is shown in broken lines in the extended position.

The heatsink 310 is ideally located at a corner of the peripheral surface 340 of the enclosure with two sides bounded by the peripheral surface 340 as illustrated in FIGS. 3A to 3D. This ensures that there is one side of the peripheral surface 340 from which the blower 305 may extend and intake air, and at least another side of the peripheral surface 340 from which heated exhaust flow may exit the enclosure through exhaust vents 315.

Exhaust vents 315 are disposed along the peripheral surface 340. FIGS. 3A and 3B show exhaust vents 315 only on one side of the peripheral surface 340 for use with the heatsink 310 such as a plate fin or pin fin heatsink that is adapted to accommodate airflow from the blower 305 to the exhaust vents 315, while FIGS. 3C and 3D show exhaust vents 315 on two sides of the peripheral surface 340 for use with the heatsink 310 such as a pin fin heatsink that is adapted for airflow from the blower 305 to two sides that form the exhaust vents 315. While FIGS. 3A to 3D show significantly complete extension of the blower 305 out of the enclosure, the extension can also be partial and can be accomplished by either sliding out or rotating out options.

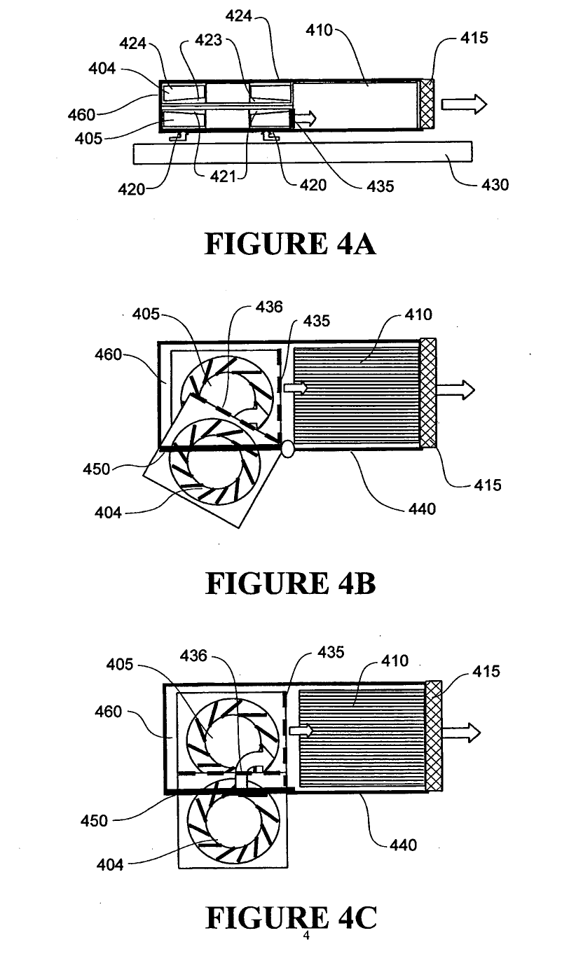

FIG. 4A shows a side view of the second embodiment cooling system, which employs two blowers, the top blower 404 and the lower blower 405 stacked one atop the other, and a heatsink 410. The heatsink 410 may be provided with extended surfaces such as plate fins, pin fins or other forms of surfaces that can be either unidirectional or omni directional depending on design requirements. As with the first embodiment, this embodiment will be described with reference to a laptop and use of the laptop on a table top working surface 430.

In this embodiment, the top blower 404 is movable between a retracted position with the top blower 404 being inside the enclosure and an extended position with the top blower 404 extended at least partially out of the enclosure. The lower blower 405 has a fixed position inside the enclosure.

The lower blower 405 fixed in its position within the enclosure has the bottom air inlet 420 exposed to the exterior of the enclosure through air inlet vents at the bottom surface of the enclosure. As such, the bottom air inlet 420 is aligned with and faces the air inlet vents which generally have a cross sectional area that is at least similar to the cross sectional area of the air inlet 420. The top air inlet 421 of the lower blower 405 can either be blocked with a solid plate or be left open.

In the retracted position, the top blower 404 sits atop the lower blower 405 with its bottom air inlet 423 facing the top air inlet 421 of the lower blower 405 and with its top air inlet 424 generally blocked by a solid surface behind the top surface of the enclosure main body. As such, neither the top inlet 424 nor the bottom air inlet 423 of the upper blower 404 has direct access to air in the retracted position. Therefore, the upper blower 404 is non-operational and is always powered off in the retracted position. The location of the air outlet 436 of the upper blower 404 is determined by how upper blower 404 is extended which will be discussed later.

To facilitate airflow communication between the blower air inlet 420 of the lower blower 405 and ambient through air inlet vents at the enclosure bottom, downward protruding standoffs are commonly attached to the bottom surface of the enclosure to elevate the enclosure off the working surface 430 and create a gap for access to air. In operation with both blowers 404 and 405 in the retracted position, the lower blower 405 is powered on with its bottom air inlet 420 open to ambient and its top air inlet 421 non-functional whether it is blocked or open as the top blower 405 is powered off and non-functional. Air from the ambient is drawn into the bottom air inlet 420 of the blower 405 through the gap and the air inlet vents and is discharged from the air outlet, represented by arrow 435, located on the side of the blower 405 facing the heatsink 410 with reference to FIG. 4C. The air from the air outlet 435 then flows into the heatsink 410 whose fins are aligned such that air can flow past the fins and out into the ambient through exhaust vents 415 located on the peripheral surface of the enclosure.

An blower aperture represented as 450 in FIG. 4C is provided on the peripheral surface 440 of the enclosure to allow the upper blower 404 to be moved in and at least partially out of the enclosure, or more specifically, the blower chamber 460 in which the upper blower 404 was positioned in the retracted position.

In operation, referring to FIGS. 4B and 4C, the second embodiment cooling system with the upper blower 404 is extended partially outside of the enclosure. The upper blower 404 can also be extended completely outside of the enclosure if required. The upper blower 404 is then powered up and is able to draw in air from its at least partially open top inlet 424 as well as bottom air inlet 423. The air is made to flow out of the outlet 436 into the blower chamber 460. If the top air inlet 421 of the lower blower 405 is blocked, the air from the blower chamber 460 then flows directly through the fins of the heatsink 410 and out through exhaust vents 415. On the other hand, if the top air inlet 421 of the lower blower 405 is open, air discharged from air outlet 436 of the upper blower 404 into the blower chamber 460 will split into two streams, one is made to flow through the heatsink 410 directly and the other is drawn into the top inlet 421 of the bottom blower 405 which is then discharged out from the blower outlet 435 of the lower blower 405 and made to flow through the heatsink 410.

The following two options can be used and more options can be devised if needed to place the outlet 436 of the upper blower 404 that will also determine how the upper blower 404 is extended out of the enclosure. One option is to have the outlet 436 of the upper blower 404 in the retracted position face the heatsink 410. To extract or extend the upper blower 404, the blower 404 is rotated out along a fixed pivot axis so that when the upper blower 404 is extended, the outlet 436 faces and directs air into the blower chamber 460, as can be seen in FIG. 4B.

Alternatively, the outlet 436 of the upper blower 404 in the retracted position is located on the side opposite the blower aperture 450. To extract or extend the upper blower 404, the upper blower 404 slides out through the blower aperture 450 so that the outlet 436 faces and directs air into the blower chamber 460 with reference to FIG. 4C.

Based on the second embodiment described herein, a laptop employing this cooling system can operate in two different modes. In the low power operating mode, the upper blower 404 stays inside the blower chamber 460 and powered off while the lower blower 405 is powered on to direct air into heatsink 410 to dissipate heat. The heat removal capacity in this mode is limited when only the lower blower 405 is operational. In the high power operating mode, both blowers 404 and 405 are powered on with lower blower 405 staying in the retracted position while the upper blower 404 is extended from the enclosure by rotating out or sliding out. The heat removal capability in this mode is naturally higher with both blowers 404 and 405 operating and directing air to heatsink 410.

Alternatively, a laptop employing this cooling system can have a single operating mode; that is the high power operating mode described above. Once the computer is powered on, both blowers 404 and 405 are powered on with lower blower 405 staying in the retracted position while the upper blower 404 is extended from the enclosure by rotating out or sliding out.

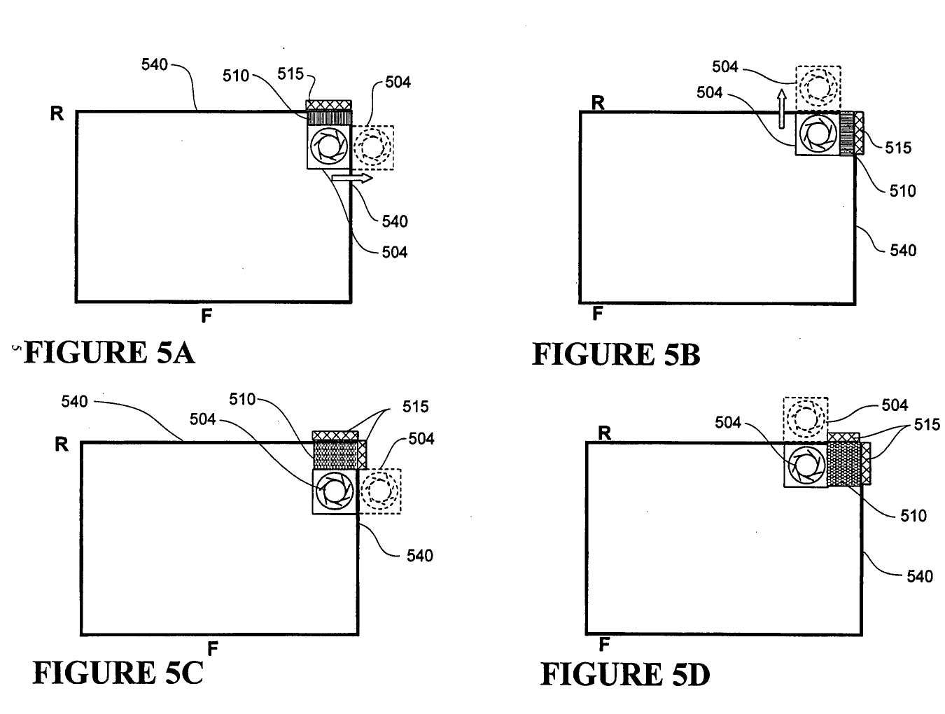

FIGS. 5A and SB show possible locations of the second embodiment cooling system in a laptop computer. The front of the laptop, where a keyboard and pointing device are normally located is indicated as ‘F’, while the rear of the laptop is indicated as ‘R’.

For clarity, only the movable upper blower 504 is shown. The lower blower 505 will have the same or similar positioning as the upper blower 504 in the retracted position. While the lower blower 505 is non-movable, the upper blower 504 can be moved from its retracted position shown with solid lines to the extended position shown with broken lines.

As with the first embodiment, the heatsink 510 is preferably located at a corner with two sides bounded by the peripheral surface 540 and with the upper blower 504 as well as the lower blower 505, in the retracted position, located next to it with reference to FIGS. 5A to SD. This ensures that there is one side of the peripheral surface 540 from which the upper blower 504 may extend and intake air, and at least another side of the peripheral surface 540 from which heated exhaust flow may exit the enclosure through exhaust vents 515.

Exhaust vents 515 are disposed along the peripheral surface 540. FIGS. 5A and 5B show exhaust vents 515 only on one side of the peripheral surface 540 for use with the heatsink 510 such as a plate fin or pin fin heatsink that is adapted to accommodate airflow from the upper blower 504 and lower blower 505 to the exhaust vents 515, while FIGS. 5C and 5D show exhaust vents 515 on two sides of the peripheral surface 540 for use with the heatsink 510 such as a pin fin heatsink that is adapted for airflow from the upper blower 504 and lower blower 505 to two sides that form the exhaust vents 515. While FIGS. 5A to 5D show significantly complete extension of the upper blower 504 out of the enclosure, the extension can also be partial and can be accomplished by either sliding out or rotating out options.

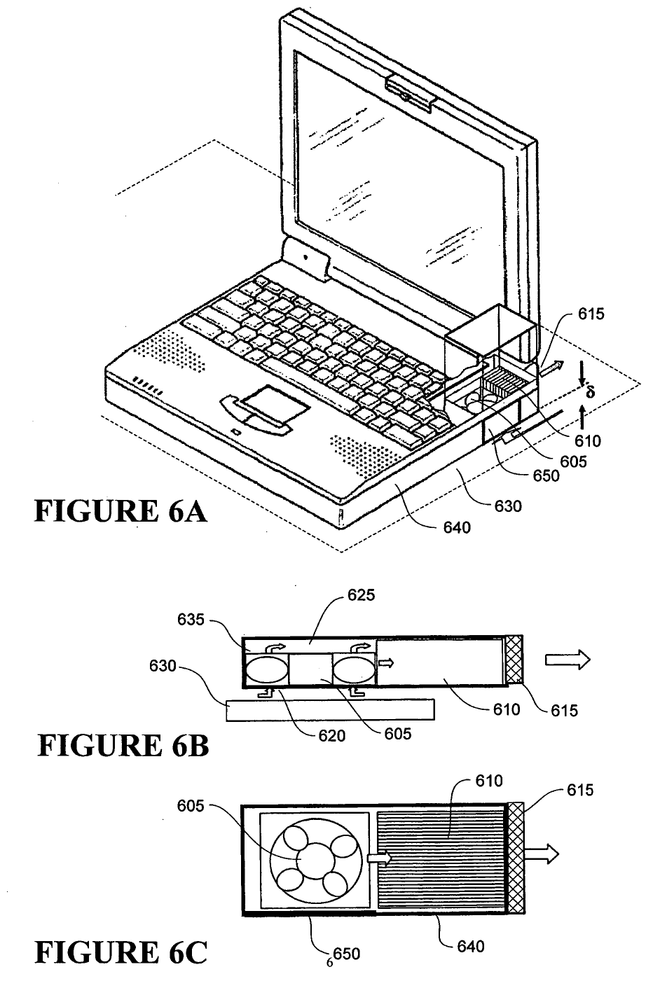

FIG. 6A shows the third embodiment cooling system, employing an axial fan 605 and a heatsink 610. As with previous embodiments, the heatsink 610 may be provided with extended surfaces such as plate fins or pin fins or other forms of surfaces that can be either unidirectional or omni directional depending on design requirements. As noted in the Background section, the axial fan differs from the radial blower in that the airflow direction at the air inlet and that at the outlet of the fan are parallel, while airflow at the inlet(s) and that at the outlet of the blower are perpendicular to one another.

In this embodiment, the axial fan 605 is movable from a retracted position inside the enclosure to an extended position at least partially outside the enclosure. Referring to FIGS. 6A to 6C, the heatsink 610 is preferably located adjacent and on the side of the fan 605 that is in the retracted position. This placement of a fan next to a heatsink may be desirable due to space limitations or other design requirements.

In the retracted position, the fan 605 is oriented such that airflow is from the bottom to the top with the air inlet 620 at the bottom and the air outlet 635 at the top. Air inlet vents in the form of finger guards or other types can be attached to or be an integral part of the fan air inlet 620 to prevent foreign objects from being inadvertently drawn into the air inlet 620. Further a bottom aperture is provided on the bottom surface of the enclosure underneath the fan 605 significantly aligned with the fan inlet 620 to allow communication between air inlet 620 and air. The bottom aperture preferably has a cross sectional area that is significantly similar to that of the air inlet 620. As an alternative, the air inlet vents can also be mounted to the bottom aperture.

When operation of the cooling system in this embodiment is required with the fan 605 in the retracted position, with reference to FIG. 6B, downward protruding standoffs are attached to the bottom surface of the enclosure to elevate the enclosure off the working surface 630 and create a gap for access to air. Further, as the heatsink 610 is located along the side of the fan 605, air flowing out of the air outlet 635 will need to be redirected from flowing upwardly out of the fan outlet 635 to horizontally through the fins of the heatsink 610. As shown in FIG. 6B, a plenum 625 is provided on top of the fan outlet 635 to achieve this.

In operation with the fan 605 in the retracted position, air from the ambient is drawn into the air inlet 620 of the fan 605 through the gap and the air inlet vents. The air is then discharged from the air outlet 635 located on the top of fan 605 into the plenum 625. As shown in FIGS. 6B and 6C, pressurized air in the plenum 625 will find its way through the heatsink fins that are aligned such that air can flow past the fins and out into the ambient through exhaust vents 615 located on the peripheral surface 640 of the enclosure.

Alternatively, when operation of the fan 605 is not required in the retracted position, the plenum 625 and the downward protruding standoffs become optional.

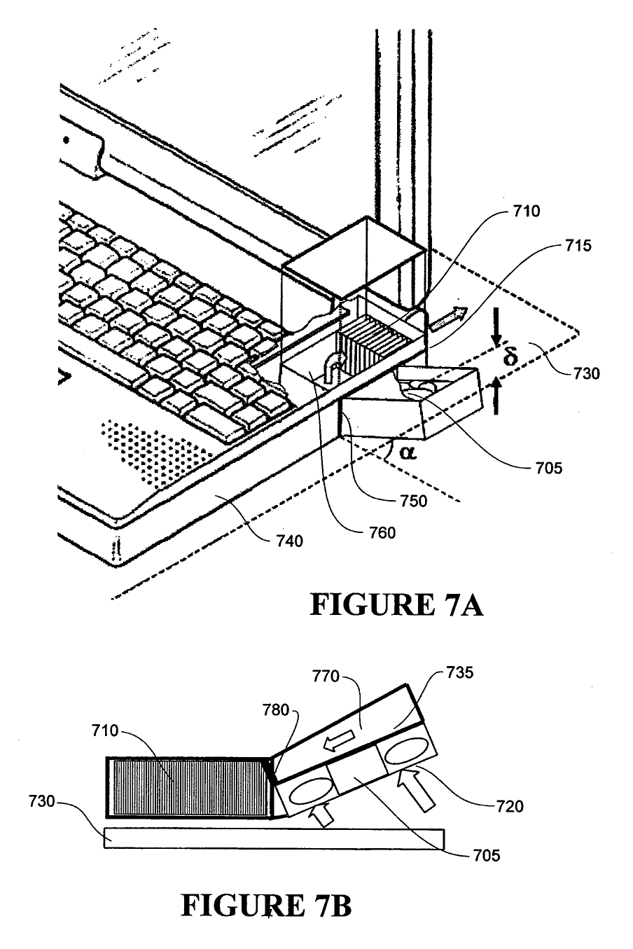

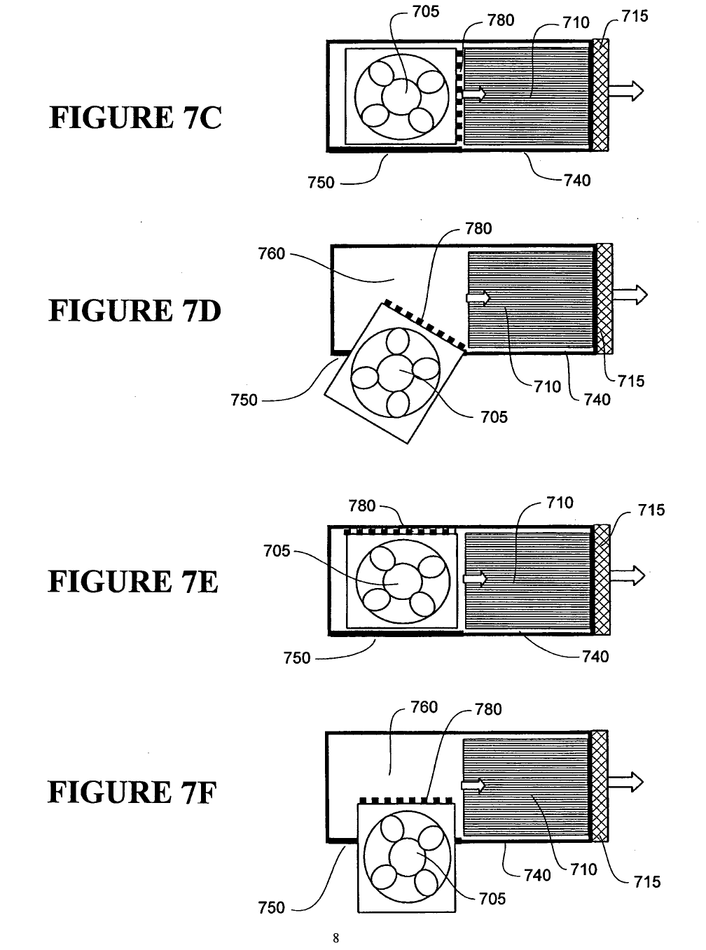

To allow the fan 605 to be moved in and out of the enclosure, and more specifically out of the fan chamber 660 in which the fan 605 was positioned in the retracted position, a fan aperture 650 is provided on the peripheral surface 640 with reference to FIG. 6A. FIGS. 7A and 7B show the third embodiment cooling system in the extended position where the axial fan 705 slides out of the enclosure through the fan aperture 750. While the fan 705 can maintain its leveled position relative to the enclosure in the extended position, it is preferable that the fan 705 is tilted to a predetermined angle a in its extended operational position relative to the position of the fan 705 in the retracted position. As shown, a wedge shaped space is formed underneath the fan 705 between a plane that defines the air inlet 720 and the working surface 730 thus affording greater access to air compared to a generally narrow gap provided underneath the laptop using standoffs. As such, the airflow impedance at air inlet 720 is reduced and airflow rate increases as a result.

In the retracted position, upwardly flowing air from the fan outlet 635 was redirected to flow to the heatsink using the plenum 625. Now, in the extended position, a similar provision is required to redirect air flowing upwardly out of the outlet 735 into the fan chamber 760 from which the fan 705 exited. With reference to FIG. 7B, a hood 770 is provided for this reason. The hood 770 may be retractable and extendable depending on the fan position. When the fan 705 is retracted inside the fan chamber 760, the hood 770 is also retracted significantly conforming to the size and shape of the interior of the plenum 725. Conversely, when the fan 705 is in the extended position outside the enclosure, the hood 770 also extends and expands if required to a predetermined size and shape. As an alternative, the hood 770 can also have a fixed size and shape that can conform to the inside of the plenum 725 when the fan 705 and the hood 770 are in the retracted position. The hood 770 acts as a plenum with a hood opening 780 facing the fan chamber 760 when the fan 705 is in the extended position.

Referring to FIGS. 7A and 7B, in operation with the fan 705 in the extended position, air is drawn into the fan inlet 720 of the fan 705 from the open sides of the wedge shaped space and discharged from the fan outlet 735 into the hood 770. From the hood 770, air exits the opening 780 and enters the fan chamber 760. Pressurized air inside the fan chamber then finds its way into the heatsink 710 whose extended surfaces are adapted such that air can flow past at least the majority of the extended surfaces of the heatsink 710 and be exhausted to the ambient through the exhaust vents 715 on the peripheral surface 740 of the enclosure.

The location of the hood opening 780 when the hood 770 along with the fan 705 is in the retracted position is determined by the cooling solution requirement and extension mechanism of the fan 705.

If it is required for this cooling system to work in both the retracted and extended position, the following option can be used and more options can be devised if needed. In the retracted position, the opening 780 faces the heatsink 710 with reference to FIG. 7C. To extract or extend the fan 705, the fan 705 is rotated out about a fixed pivot axis so that when the fan 705 is moved outside at least partially, the hood opening 780 faces and directs air into the fan chamber 760 with reference to FIG. 7D. However, if the cooling solution is only required to operate in the extended position, in addition to the aforementioned rotate-out option with reference to FIGS. 7C and 7D, the following option can be used. In the retracted position, the hood opening 780 faces the side opposite and significantly parallel to the aperture 750 with reference to FIG. 7E. Since this option does not allow airflow path from the fan air outlet 735 to the exhaust vents 715 when the fan 705 is in the retracted position, the fan 705 needs to be powered off in the retracted position. To extract or extend the fan 705, the fan 705 slides out from the fan chamber 760 through the aperture 750 with the hood opening 780 facing and directing air into the fan chamber 760 with reference to FIG. 7F. In both options, the fan 705 can be extracted out partially or completely.

Similar to previous embodiments, the cooling system in this embodiment can be adapted to allow operation in two modes or in one mode. Two operating modes involve a low cooling capacity operation with the fan 705 in the retracted position, allocation of plenum 625 and the hood opening 780 facing the heatsink 710 when the fan 705 is in the retracted position with reference to FIG. 7C, and a high cooling capacity operation with the fan 705 in the extended position shown in FIGS. 7A, 7B and 7D with the fan 705 being extracted by rotating out. Alternatively, the cooling system in this embodiment can be designed for a single mode operation; that is the cooling system will only operate with the fan 705 in the extended position illustrated in FIGS. 7A and 7B either by rotating out (FIG. 7D) and sliding out (FIG. 7F).

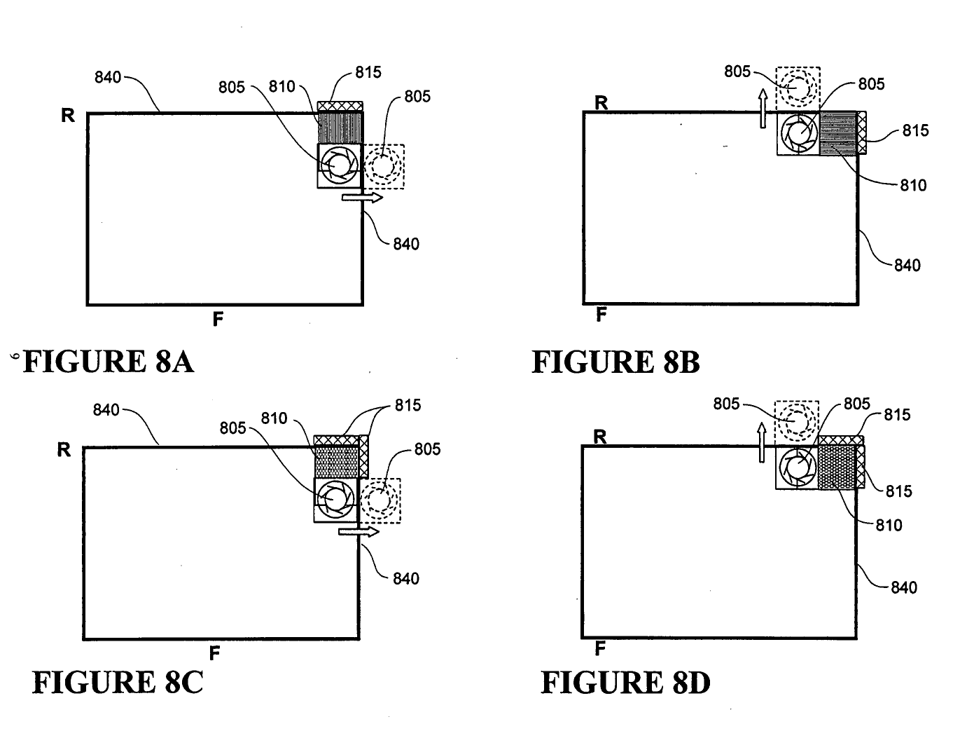

FIGS. 8A to 8D show possible locations of the third embodiment cooling system in a laptop computer. The front of the laptop, where a keyboard and pointing device are normally located is indicated as ‘F’, while the rear of the laptop is indicated as ‘R’.

The axial fan 805 is shown in solid lines in the retracted position, and in broken lines in the extended position. FIGS. 8A to 8D show a substantially complete extension of the fan 805 outside of the enclosure. This is not necessary. The fan 805 can be moved outwardly so as to be only partially outside.

As with earlier embodiments, the heatsink 810 is preferably located at a corner of the peripheral surface 840 of the enclosure with two sides bounded by the peripheral surface 840 and with the fan 805, in the retracted position, located next to it with reference to FIGS. 8A to 8D. This ensures there is one side of peripheral surface 840 from which the fan 805 may extend and intake air, and at least another side of peripheral surface 840 from which heated exhaust flow may exit the enclosure through exhaust vents 815.

Exhaust vents 815 are disposed along the peripheral surface 840. FIGS. 8A and 8B show exhaust vents 815 only on one side of the peripheral surface 840 for use with the heatsink 810 such as a plate fin or pin fin heatsink that is adapted to accommodate airflow from the fan 805 to the exhaust vents 815, while FIGS. 8C and 8D show exhaust vents 815 on two sides of the peripheral surface 840 for use with the heatsink 810 such as a pin fin heatsink that is adapted for airflow from the fan 805 to two sides that form the exhaust vents 815. While FIGS. 8A to 8D show significantly complete extension of the fan 805 out of the enclosure, the extension can also be partial and can be accomplished by either sliding out or rotating out options.

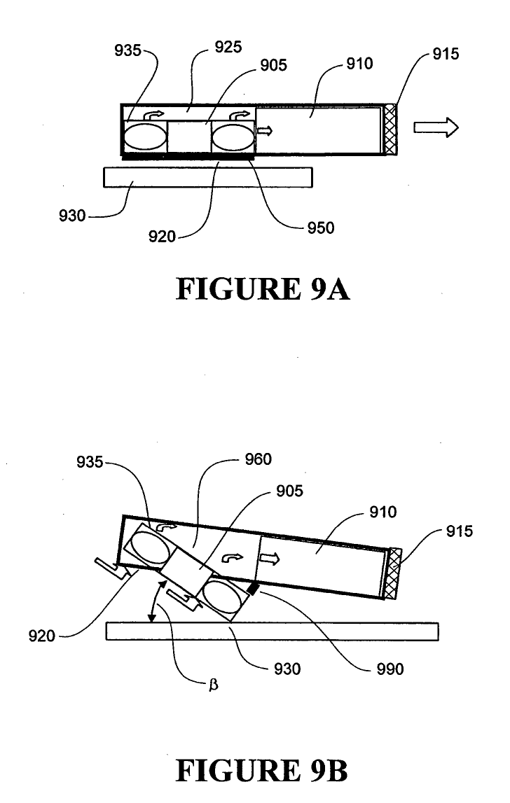

FIG. 9A shows the fourth embodiment cooling system, where an axial fan 905 is used as the air flow device to cool the heatsink 910. As with previous embodiments, the heatsink 910 may be provided with extended surfaces such as plate fins, pin fins or other forms of surfaces that can be either unidirectional or omni directional depending on design requirements.

In this embodiment, the fan 905 is movable between a retracted position with the fan 905 significantly contained inside the enclosure of an electronic device and an extended position with the fan 905 extended out of the enclosure at least partially from underneath or the bottom surface of the enclosure. Referring to FIG. 9A, the heatsink 910 is preferably located adjacent and on the side of the fan 905 that is in the retracted position. This placement of a fan next to a heatsink may be desirable due to space limitations or other design requirements.

In the retracted position, the fan 905 is oriented such that airflow is from the bottom to the top with the air inlet 920 at the bottom and with the air outlet 935 at the top. Air inlet vents in the form of finger guards or other types can be attached to or be an integral part of the fan air inlet 920 to prevent foreign objects from being inadvertently drawn into the air inlet 920. The fan air inlet 920 is then exposed to the exterior of the enclosure through a fan aperture 950 located on the bottom surface of the enclosure underneath the fan 905 significantly aligned with the air inlet 920. The fan aperture 950 typically has a cross sectional area that is at least the same size as the cross sectional area of the fan 905 so that the fan 905 can move inside and outside of the enclosure or more specifically the fan chamber 960 that the fan 905 occupies in the retracted position.

When operation of the cooling system in this embodiment is required with the fan 905 in the retracted position, with reference to FIG. 9A, downward protruding standoffs are attached to the bottom surface of the enclosure to elevate the enclosure off the working surface 930 and create a gap for access to air. Further, as the heatsink 910 is located along the side of the fan 905, air flowing out of the air outlet 935 will need to be redirected from flowing upwardly out of the fan outlet 935 to horizontally through the fins on the heatsink 910. As shown in FIG. 9A, a plenum 925 is provided on top of the fan outlet 935 to achieve this.

In operation with the fan 905 in the retracted position, air from the ambient is drawn into the air inlet 920 of the fan 905 through the gap and the fan aperture 950 at the bottom of the enclosure. The air is then discharged from the air outlet 935 located on the top of fan 905 into the plenum 925. As shown in FIG. 9A, pressurized air in the plenum 925 will find its way through the heatsink fins that are aligned such that air can flow past the fins and out into the ambient through exhaust vents 915 located on the peripheral surface of the enclosure.

Alternatively, when operation of the fan 905 is not required in the retracted position, the plenum 925 and the downward protruding standoffs become optional.

FIG. 9B shows the fourth embodiment cooling system in an extended position. In this extended position, the axial fan 905 moves out from the bottom surface of the enclosure through the fan aperture 950. Once outside, the fan 905 tilts relative to the position of the fan is 905 in the retracted position such that a wedge shaped space is formed with a predetermined angle β between the plane of fan air inlet 920 and the working surface 930. The tilt angle β is adapted to provide the axial fan 905 better access to air by allowing the air inlet 920 to face the open side of the wedge shaped space and by directing discharged air from the air outlet 935 to the fan chamber 960 and to the heatsink 910. As such, the airflow impedance at the fan inlet 920 is reduced and airflow rate increases as a result as compared to the generally narrow gap provided by standoffs and working surface 930 and small plenum 925 at the fan outlet 935 when the fan is in the retracted position.

The tilted fan 905 under the enclosure will cause the enclosure to tilt with reference to the working surface 930. While the impact of how the enclosure tilts on the operation or performance of the cooling system may not be significant, to avoid the enclosure to tilt in a way that is ergonomically unfriendly and awkward to operate, it is desirable to keep the fan 905 near or along the rear side of the enclosure. As such, the enclosure will tilt in an ergonomically friendly way when the fan 905 is in the extended position with the front edge of the enclosure being close to the working surface 930 and the rear edge elevated above the working surface 930. To ensure that the enclosure can rest stably on the working surface 930, supporting legs or structures that are preferably extendable and retractable preferably in sync with the extension and retraction of the fan 905 will be attached to the bottom side of the enclosure or to the fan 905 protruding downwardly toward the working surface 930.

Further, depending on the angle β of the wedge shaped space and the extent that the fan 905 extends out of the enclosure, it may also be necessary to provide airflow one or more baffles or a hood such as on shown in FIG. 9B as 990 at the fan outlet 935 to ensure that air discharged from the air outlet 935 does not leak into the ambient but is instead directed toward the heatsink 910.

Referring to FIG. 9B, in operation with the fan 905 in the extended position, air is drawn into the fan inlet 920 from the open side of the wedge shaped space and discharged from the fan outlet 935 into the fan chamber 960. Pressurized air inside the fan chamber then finds its way into the heatsink 910 whose extended surfaces are adapted such that air can flow past at least the majority of the extended surfaces of the heatsink 910 and be exhausted to the ambient through the exhaust vents 915 on the peripheral surface 940 of the enclosure.

Similar to previous embodiments, the cooling system in this embodiment can be adapted to allow operation in two modes or in one mode. Two operating modes involve a low cooling capacity operation with the fan 905 in the retracted position and allocation of plenum 925 and downward protruding standoffs shown in FIG. 9A and a high cooling capacity operation with the fan 905 in the extended position shown in FIG. 9B. Alternatively, the cooling system in this embodiment can be designed for a single mode operation; that is the cooling system will only operate with the fan 905 in the extended position illustrated in FIG. 9B.

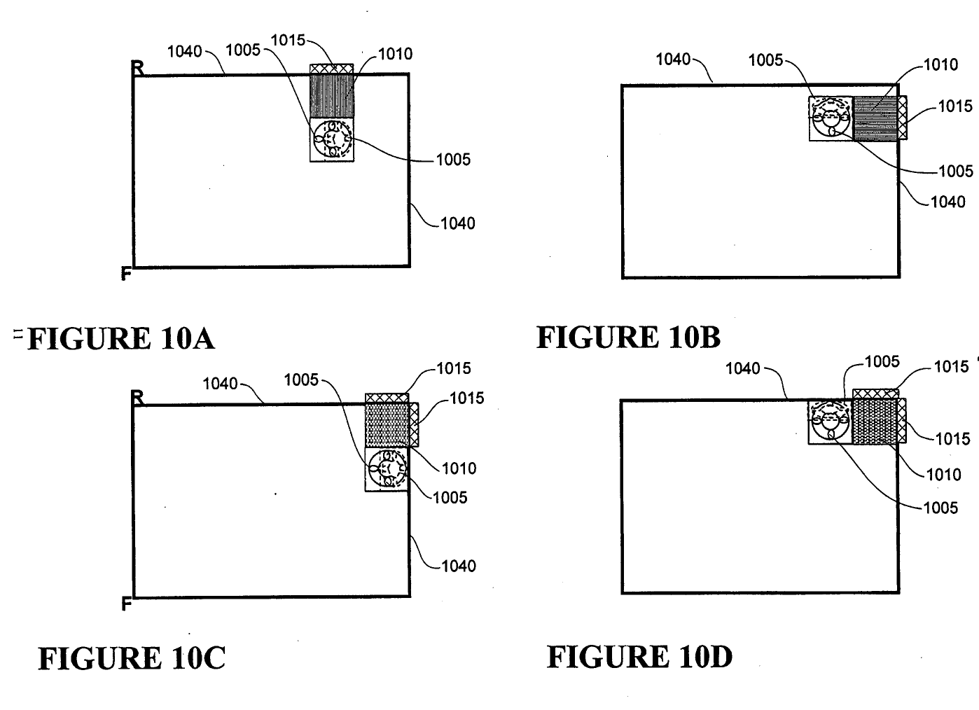

FIGS. 10A to 10D show possible locations of the cooling system of the fourth embodiment in a laptop computer. The front of the laptop, where a keyboard and pointing device are normally located is indicated as ‘F’, while the rear of the laptop is indicated as ‘R’.

The axial fan 1005 is located within the enclosure when it is in the retracted position, shown in solid lines in FIGS. 10A to 10D. In the extended position, the fan 1005 moves at least partially out of the enclosure from underneath the enclosure and is tilted with respect to the position of the fan 1005 in the retracted position. This extended position is shown in broken lines in FIGS. 10A to 10D.

Since the fan 1005 is extended out from the bottom of the enclosure, the fan 1005 does not need to be bounded by the peripheral surface 1040 of the enclosure as compared to the discussions of embodiments one, two and three. Therefore, the heatsink 1010 can be located in the enclosure with only one side bounded by the peripheral surface 1040 with the fan 1005 located on its side as shown in FIGS. 10A and 10B when the heatsink 1010 has extended surfaces such as plate fins or pin fins, that are adapted to airflow between the fan 1005 and the exhaust vents 1015.

Alternatively, the heatsink 1010 shown in FIGS. 10C and 10D can also be located at a rear corner bounded on two sides of the peripheral surface 1040, when the heatsink 1010 has extended surfaces, such as pin fins that are adapted for airflow between the fan 1005 and the exhaust vents 1015 on two sides of the peripheral surface 1340. While not shown, when the heatsink 1010 is located at a rear corner, the exhaust vents 1015 can also be located at only on side of the peripheral surface 1040 when the heatsink 1010 has extended surfaces, such as plate fins or pin fins that are adapted for airflow between the fan 1005 and the exhaust vents 1015 on one of the peripheral surface 1040.

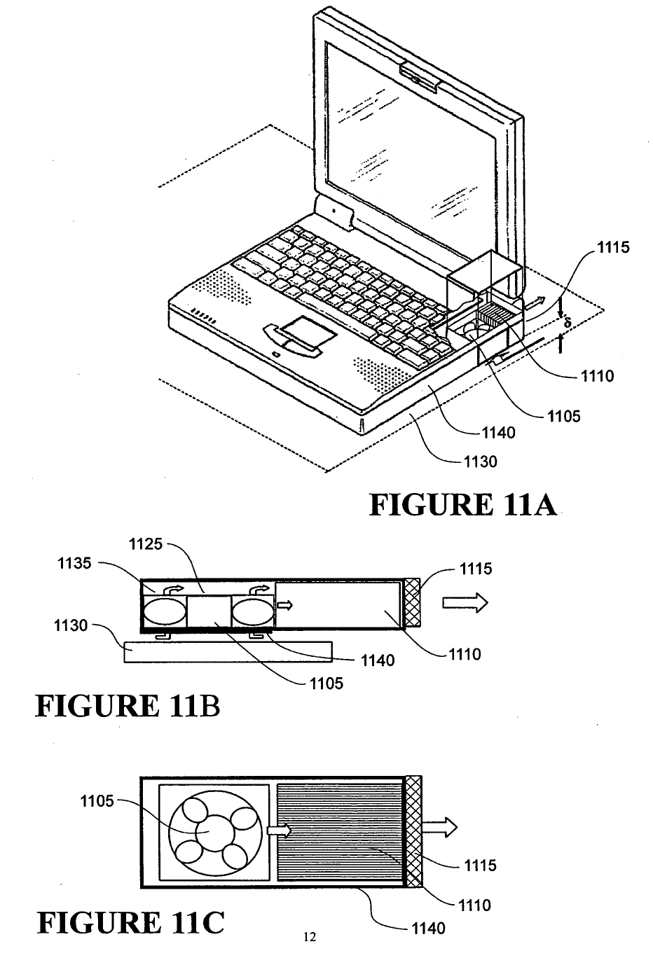

FIG. 11A shows the fifth embodiment cooling system as installed inside the main body enclosure of a laptop computer. As with the previous two embodiments, the fifth embodiment cooling system employs an axial fan 1105 to cool a heatsink 1110, which could have plate fins, pin fins or other forms of extended surfaces that can be either unidirectional or omni directional depending on design requirements.

In this embodiment, the fan 1105 is movable between a retracted position with the fan 1105 substantially contained inside the main body enclosure and an extended position with the fan 1105 extended at least partially out of the enclosure from underneath or the bottom surface of the enclosure. Referring to FIGS. 11A to 11C, the heatsink 1110 is preferably located adjacent and on the side of the fan 1105 that is in the retracted position. This placement of a fan next to a heatsink may be desirable due to space limitations or other design requirements.

In the retracted position, the fan 1105 is oriented such that airflow is from the bottom to the top with the air inlet 1120 at the bottom and with the air outlet 1135 at the top. Air inlet vents in the form of finger guards or other types can be attached to or be an integral part of the fan 1105 to prevent foreign objects from being inadvertently drawn into the air inlet 1120. The fan air inlet 1120 is then exposed to the exterior of the enclosure through a fan aperture 1150 as shown in FIG. 11B located on the bottom surface of the enclosure underneath the fan 1105 significantly aligned with the air inlet 1120. The fan aperture 1150 typically has a cross sectional area that is at least the same size as the cross sectional area of the fan 1105 so that the fan 1105 can move inside and outside of the enclosure or more specifically the fan chamber 1160 that the fan 1105 occupies in the retracted position through the fan aperture 1150.

When operation of the cooling system in this embodiment is required with the fan 1105 in the retracted position, with reference to FIG. 11B, downward protruding standoffs are attached to the bottom surface of the enclosure to elevate the enclosure off the working surface 1130 and create a gap for access to air. Further, with the heatsink 1110 being located along the side of the fan 1105, air flowing out of the air outlet 1135 will need to be redirected from flowing upwardly out of the fan outlet 1135 to horizontally through the fins on the heatsink 1110. As shown in FIG. 11B, a plenum 1125 is provided on top of the fan outlet 1135 to achieve this.

In operation with the fan 1105 in the retracted position, air from the ambient is drawn into the air inlet 1120 of the fan 1105 through the gap and the fan aperture 1150 at the bottom of the enclosure. The air is then discharged from the air outlet 1135 located on the top of fan 1105 into the plenum 1125. As shown in FIGS. 11B and 11C, pressurized air in the plenum 1125 will find its way through the heatsink fins that are aligned such that air can flow past the fins and out into the ambient through exhaust vents 1115 located on the peripheral surface 1140 of the enclosure.

Alternatively, when operation of the fan 1105 is not required in the retracted position, the plenum 1125 and the downward protruding standoffs become optional.

Referring to FIG. 11B, to facilitate operation with the fan 1105 in the extended position, a heatsink aperture is provided on the bottom surface underneath the heatsink 1110, for purposes that will later be described. The heatsink aperture has a cross sectional area that is typically at least similar to the cross sectional area of the heatsink 1110 and should be covered with a solid plate or cover when the heatsink 1105 is operating in the retracted position in order to eliminate airflow bypass.

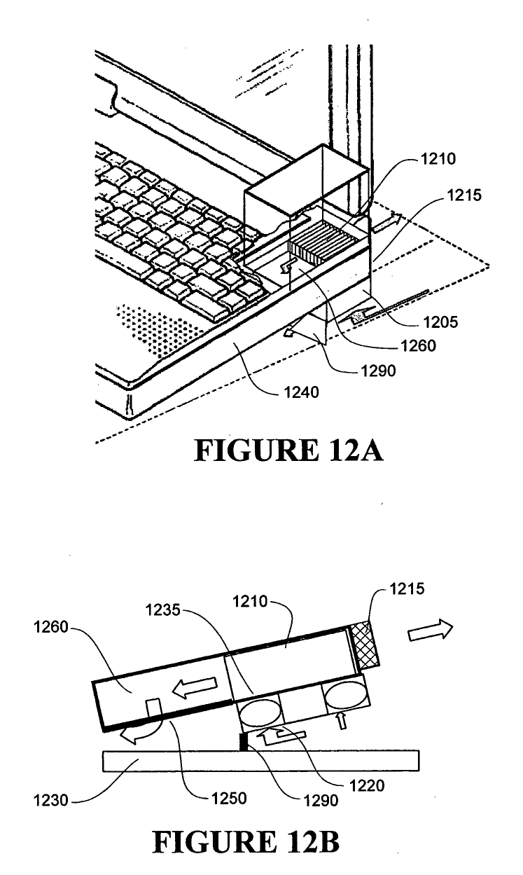

Referring to FIGS. 12A and 12B, the fifth embodiment cooling system is shown in the extended position. In this position, the axial fan 1205 has moved out of the fan chamber 1260 from underneath through the fan aperture 1250 provided on the bottom surface of the enclosure. The fan 1205 is also moved toward the heatsink 1210 to substantially cover the underside of the heatsink 1210. In the process, the fan 1205 maintains its bottom to top airflow direction.

A mechanism is provided to move the solid cover that covers the heatsink aperture underneath the heatsink 1210. When the fan 1205 moves toward the heatsink 1210, the cover makes way for the incoming fan 1205. This precise motion may be altered, for instance, by having the solid cover of the underside of the heatsink 1210 to open just before the fan 1205 is moved to the extended position. Therefore, when the fan 1205 moves into the extended position that substantially covers the heatsink 1210 from underneath, the underside of the heatsink 1210 is at least partially open to the fan outlet side 1235. Better results can be achieved when the opening underneath the heatsink 1210 and the cross-sectional area of the heatsink 1210 exposed to the fan 1205 are adapted to allow the underside of the heatsink 1210 to be substantially covered by airflow coming out from the fan outlet 1235.

As can be seen in FIG. 12B, once the fan 1205 is moved to cover the underside of the heatsink 1210, the bottom surface of the enclosure will be elevated off the working surface 1230 beyond the height of the original standoffs if available, and will tilt relative to the working surface 1230 in a way determined by the location of the fan 1205. While the impact of how the enclosure tilts on the operation or performance of the cooling system may not be significant, to avoid the enclosure to tilt in a way that is ergonomically unfriendly and awkward to operate, it is desirable to keep the fan 1205 in the extended position near the rear side of the enclosure When the fan 1205 is located near the rear edge in the extended position, the enclosure will tilt with the front edge of the enclosure being close to the working surface 1230 and the rear edge elevated from the working surface 1230 to at least the thickness of the fan. This tilt may be ergonomically desirable, for instance where the device is laptop computer with its keyboard located on the top surface, as many standard laptops and keyboards are designed.

When the enclosure tilts as described, a wedge shaped space forms between the plane of the fan air inlet 1220 and the working surface 1230 allowing air inlet 1220 access to air through the open side of the wedge shaped space. To reduce airflow impedance at the fan inlet 1220, it may be desirable to increase the tilt angle by raising the rear side of the enclosure to a predetermined height, preferably beyond the thickness of the fan by addition of supporting legs or structure under the bottom surface or under the fan 1205. Preferably, supporting legs or structure are also adapted to ensure that the enclosure rests on the working surface 1230 stably and to be retractable and extendable preferably in sync with the retraction and extension of the fan 1205.

In this extended position, air is drawn into the fan air inlet 1220 from the open side of the wedge shaped space, as shown in FIG. 12B, and discharged from air outlet 1235 to the heatsink 1210 from the underside. One stream of the exhaust air exits from one end of the heatsink 1210 through exhaust vents 1215 located on the peripheral surface 1240 of the enclosure. Another stream of the exhaust air exits from the second and opposite end of the heatsink 1210 into the fan chamber 1260 vacated by the fan 1205 and into the ambient through the gap between the bottom surface of the enclosure and the working surface 1230. As such, it may be desirable to have one or more air baffles separating the fan air inlet 1220 from exhaust air stream coming out from the second end of the heatsink 1210. With reference to FIG. 12B, an air baffle 1290 may be installed preferably along the edge of the fan air inlet 1220 or from the underside of the enclosure bottom surface adjacent the fan air inlet 1220 extending downward all the way to the working surface 1230 to minimize hot air recirculation into fan air inlet 1220. Further, the air one or more baffles can also act as at least a part of the aforementioned supporting legs or structure.

Similar to previous embodiments, the cooling system in this embodiment can be adapted to allow operation in two modes or in one mode. Two operating modes involve a low cooling capacity operation with the fan 1105 in the retracted position and allocation of plenum 1125 and downward protruding standoffs shown in FIGS. 11A-11C and a high cooling capacity operation with the fan 1205 in the extended position shown in FIGS. 12A and 12B. Alternatively, the cooling system in this embodiment can be designed for a single mode operation; that is the cooling system will only operate with the fan 1205 in the extended position illustrated in FIGS. 12A and 12B. When the cooling system in this embodiment is only required to operate in the extended position, the cover underneath the heatsink 1210 becomes optional.

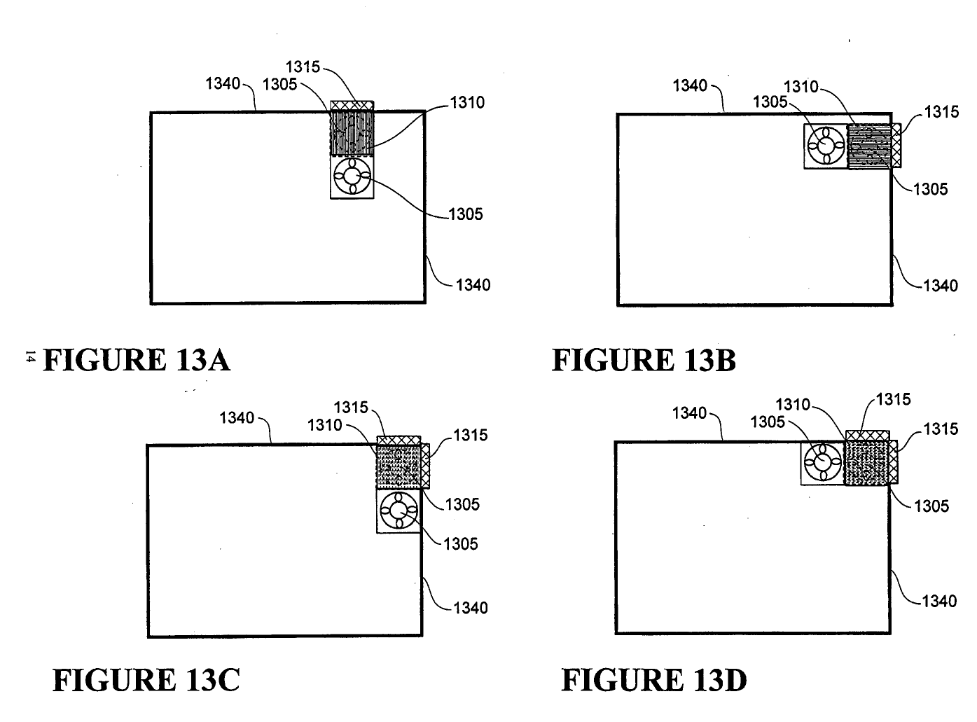

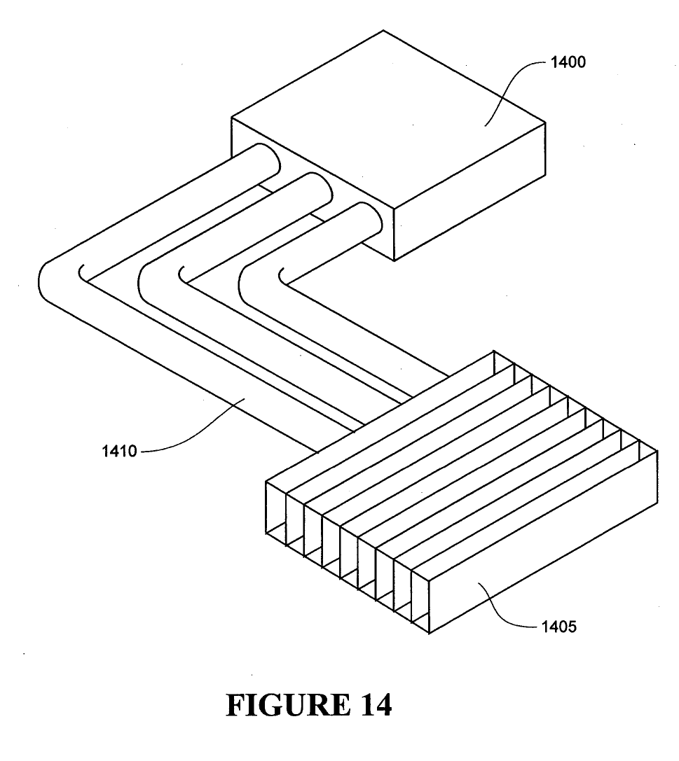

FIGS. 13A to 13D show possible locations of the cooling system within a laptop's main body enclosure. The front of the main body, where a keyboard and pointing device are normally located is indicated as ‘F’, while the rear of the laptop is indicated as ‘R’.

The axial fan 1305 is located within the enclosure when it is in the retracted position, shown in solid lines in FIGS. 13A to 13D. In the extended position, the fan 1305 moves out of the enclosure from underneath the enclosure and moves to underneath the fan 1310. This extended position is shown in broken lines in FIGS. 13A to 13D.

As illustrated in FIGS. 13A and 13B, the heatsink 1310 can be located with only one side bounded by the peripheral surface 1340 of the enclosure and the fan 1305, in the retracted position, located on its side when the heatsink 1310 has extended surfaces such as plate fins or pin fins, that are adapted to airflow between the fan 1305 and the exhaust vents 1315.

Alternatively, the heatsink 1310 shown in FIGS. 13C and 13D can also be located at a rear corner bounded by two sides of the peripheral surface 1340, when the heatsink 1310 has extended surfaces, such as pin fins shown in FIGS. 13C and 13D that are adapted for airflow between the fan 1305 and the exhaust vents 1315 on two sides of the peripheral surface 1340. While not shown, when the heatsink 1310 is located at a rear corner, the exhaust vents 1315 can also be located at only one side of the peripheral surface 1340 when the heatsink 1310 has extended surfaces, such as plate fins or pin fins that are adapted for airflow between the fan 1305 and the exhaust vents 1315 on one of the peripheral surface 1340.

The text above describes one or more specific embodiments of a broader invention. The invention also is carried out in a variety of alternative embodiments and thus is not limited to those described here. Those other embodiments are also within the scope of the following claims.

While the invention and exemplary embodiments of the invention have been illustrated and described in general and specific terms, it should be understood that the invention may be modified and otherwise embodied in still other forms, including but not limited to all forms which are obvious variants of or equivalent to those disclosed.

The preceding descriptions are by way of example and are not intended to limit or restrict the scope of the invention which is specified and defined by the appended claims.

I claim:

1. A cooling system for a device having an enclosure and at least one heat-generating electronic component operating within the enclosure, the cooling system comprising:
a heat receiving section thermally and mechanically coupled to the heat-generating electronic component;
a heatsink coupled to the heat receiving section; and
an air flow device movable between a retracted position, where the air flow device is completely inside the enclosure, and an extended position, where the air flow device is at least partially outside the enclosure;
wherein the air flow device in the extended position is adapted to direct air into the enclosure to dissipate heat from the heatsink.

2. The cooling system of claim 1 wherein the air flow device is further adapted to direct air into the enclosure in the retracted position to dissipate heat from the heatsink.

3. The cooling system of claim 1 wherein the air flow device is movable between the retracted and extended positions by sliding the air flow device in and out of the enclosure.

4. The cooling system of claim 1 wherein the air flow device is movable between the retracted and extended positions by rotating the air flow device about a pivot.

5. The cooling system of claim 1 wherein the air flow device is movable between the retracted and extended positions by tilting the air flow device in and out of the enclosure.

6. The cooling system of claim 1 wherein the air flow device is tilted in the extended position.

7. The cooling system of claim 1 wherein the air flow device directs air into a chamber that exists when the air flow device is in the extended position.

8. The cooling system of claim 1 wherein at least a portion of the underside of the heatsink is exposed to air outside said enclosure.

9. The cooling system of claim 8 wherein a movable cover is provided to substantially cover the exposed underside portion of the heatsink when the air flow device is in the retracted position, and the cover is moved when the air flow device is in the extended position to expose at least a portion of underside of the heatsink.

10. The cooling system of claim 9 wherein the air flow device in the extended position substantially overlaps the exposed underside of the heatsink and is adapted to direct air toward the heatsink.

11. The cooling system of claim 8 wherein the air flow device in the extended position substantially overlaps the exposed underside of the heatsink and is adapted to direct air toward the heatsink.

12. A computing system comprising:
an enclosure;
one or more heat-generating electronic components including at least one CPU;
one or more storage sub-systems;
one or more memory modules;
a cooling unit, said cooling unit further comprising:
one or more heat receiving sections thermally and mechanically coupled to one or more heat-generating electronic components;
a heatsink coupled to the heat receiving sections; and
an air flow device movable between a retracted position, where the air flow device is completely inside the enclosure, and an extended position, where the air flow device is at least partially outside the enclosure;
wherein the air flow device in the extended position is adapted to direct air into the enclosure to dissipate heat from the heatsink.

13. The computing system of claim 12 wherein the air flow device is further adapted to direct air into the enclosure in the retracted position.

14. The computing system of claim 12 wherein the air flow device is movable between the retracted and extended positions by sliding the air flow device in and out of the enclosure.

15. The computing system of claim 12 wherein the air flow device is movable between the retracted and extended positions by rotating the air flow device about a pivot.

16. The computing system of claim 12 wherein the air flow device is movable between the retracted and extended positions by tilting the air flow device in and out of the enclosure.

17. The computing system of claim 12 wherein the air flow device is tilted in the extended position.

18. The computing system of claim 12 wherein the air flow device directs air into a chamber that exists when the air flow device is in the extended position.

19. The computing system of claim 12 wherein at least a portion of the underside of the heatsink is exposed to air outside said enclosure.

20. The computing system of claim 19 wherein a movable cover is provided to substantially cover the exposed underside portion of the heatsink when the air flow device is in the retracted position, and the cover is moved when the air flow device is in the extended position to expose at least a portion of underside of the heatsink.

21. The computing system of claim 20 wherein the air flow device in the extended position substantially overlapping the exposed underside of the heatsink and is adapted to direct air toward the heatsink.

22. The computing system of claim 19 wherein the air flow device in the extended position substantially overlaps the exposed underside of the heatsink and is adapted to direct air toward the heatsink.
